(19) United States
(12) Patent Application Publication
(10) Pub. No.: US 2002/0062278 A1
(43) Pub. Date: May 23, 2002

(54) Method and system for international e-commerce

(76) Inventors: Bradley Kent Ingram, Danville, CA (US); Jerry M. Ricarlo, Danville, CA (US)

Correspondence Address: John L. Rogitz Esquire, Rogitz & Associates, 750 "B" Street, Suite 3120, San Diego, CA, 92101, US

(21) Appl. No.: 09/507,183

(22) Filed: Feb. 18, 2000

(51) Int. Cl. G06F 17/60

(52) U.S. Cl. 705/39

(57) ABSTRACT

A method and system for international e-commerce includes issuing a debit card to a user based on a user account of funds in a user currency. The user can then access a Web merchant who transacts business in a merchant currency, and using the debit card, the user can select products for purchase. The user is automatically redirected to a transaction center Web site, which authenticates the user and determines appropriate tariffs and shipping costs, based on the user's shipping address, and the cost and weight of products. The transaction center then converts the total amount to the user currency and verifies that the user has sufficient funds to cover the transaction. If funds are available, the transaction center approves the transaction, notifies the merchant and user, automatically debits the user account, and automatically generates a shipping manifest. The debited funds are then converted to merchant currency and the merchant is paid, and the shipping manifest is sent to the merchant. After shipment has occurred and the tariffs paid, the transaction center is invoiced by the shipper, and the shipper is paid in the shipper's currency, ordinarily the merchant currency.

### FIELD OF THE INVENTION

The present invention relates generally to e-commerce.

### BACKGROUND

The explosive growth of e-commerce has promoted economic growth world-wide. Consumers can now order goods and services from merchants throughout the world simply by accessing a merchant's Web site and selecting products for purchase. This can be accomplished at any time, anywhere in the world the consumer has Internet access, provided the user has a credit card, such as an international credit card, that is accepted by the merchant and that the user is willing to divulge over the Internet. Therein lies a problem addressed herein.

Specifically, many if not most consumers in a large number of non-U.S. countries do not have international credit cards or choose not to use them, for a number of reasons, the perceived lack of security at merchant sites being one of them. Instead, they have credit cards issued by local banks on accounts in the consumer's home currency, and because of the risks entailed in currency conversion, online merchants ordinarily refuse payment in currencies other than the merchant's currency. This is because in credit card transactions, the conversion occurs when the credit agency settles the transaction perhaps days or even weeks after the transaction occurs, during which time exchange rates might vary significantly. When the exchange rate varies between the time of purchase and the transaction settlement date, either the merchant or the purchaser must bear the risk of the change.

U.S. Pat. No. 5,897,621 attempts to address the above issue by essentially permitting a transaction to occur if the price a consumer is willing to pay in the consumer's currency, after conversion to a merchant's currency, is within some risk range of the price demanded by the merchant. In this way, the risk of currency conversion is shifted from the consumer and merchant to an approving agency which determines whether the risk range criteria has been met.

Unfortunately, the risk of currency conversion in the above-referenced patent is treated as a simple one-dimensional problem. Not only does the above-referenced patent require a risk evaluation for each transaction that requires a consumer to input what amounts to a guess at a fair market price in a currency not used by the Web merchant, thus requiring some notion on the part of the consumer at what the exchange rate might happen to be, but it also fails to account for other important factors related to international commerce. The present invention, for example, recognizes that international commerce almost always raises issues of tariff payment and shipping charges, which are often unknown to the parties at the time of the transaction and which consequently can represent hidden costs or at least costs the magnitude of which can be somewhat uncertain at purchase time. These factors are not considered in the above-referenced patent. Moreover, the above-referenced patent does not appear to contemplate the practicality of how to pay the approving agency for its services. The present invention recognizes that it would be advantageous to account for these factors at the time of transaction and in the appropriate currency, so that both parties can agree to and understand the full costs that are to be borne in association with the transaction.

### SUMMARY OF THE INVENTION

A computer-implemented method for international e-commerce includes permitting at least one user having an account in a user currency to access at least one merchant computer site to select one or more products for purchase. The products have respective purchase prices in a merchant currency. A shipping address is received from the user and then a tariff is determined, if any, for each product, at least partially based on the shipping address, i.e., on the country to which the product is to be shipped. A shipping charge for each product is also determined at least partially based on the shipping address. Next, the method includes determining whether sufficient funds exist in the user account to cover at least the purchase price or prices of the products, and if sufficient funds exist in the user account, a transaction is allowed and the user account is debited accordingly. Funds are then provided to the merchant in the merchant currency pursuant to the transaction, and the shipping cost and tariff are provided to the merchant or to a third party shipper, depending on who ships the goods. Preferably, a total cost in both the user currency and the merchant currency is presented to the user.

In a preferred embodiment, the method includes redirecting the user accessing a merchant Web site to a transaction center once the user selects a product to buy, which undertakes the determining acts set forth above. In addition, the transaction center determines a merchant discount based on the transaction, and associates the merchant discount with an account associated with the transaction center. Moreover, a shipping commission is determined based on the shipping charge and applied to an account associated with the transaction center.

As set forth in detail below, in the preferred embodiment information pertaining to tariffs is stored for use of the information in determining a tariff, while information pertaining to shipping charges is stored for use in determining a shipping charge. The information pertaining to shipping charges can at least partially account for weights of goods.

In one particularly preferred embodiment, the method includes appending a timestamp to each transaction, and using the timestamp to convert the amount of the transaction from the merchant currency to the user currency to determine whether sufficient funds exist. If desired, the method can include generating a shipping document pursuant to the transaction, and shipping the product in accordance with the shipping document and shipping cost. The preferred act of determining whether sufficient funds exist further includes calculating a currency conversion between the user currency and merchant currency using a static spread around a fluctuating exchange rate.

In another aspect, a computer system is disclosed for international electronic commerce. The system includes at least one user computer and at least one merchant computer accessible to the user computer via a wide area computer network, such that a transaction for goods or services can be undertaken by the computers. At least one transaction center computer accesses the network and determines shipping costs and tariff costs based on the transaction.

In still another aspect, a computer program product can cause a computer to undertake international e-commerce over the world wide web. The program product includes logic means for determining, in at least a user currency, a sales cost for a product having a sales cost listed on a merchant web site in a merchant currency. The program product further includes logic means for determining at least a shipping cost associated with the product. Logic means are provided for presenting to a user a total cost of the product, the total cost including at least the sales cost and shipping cost.

In yet another aspect, a method for undertaking e-commerce includes establishing communication between a user computer and a merchant computer via a wide area computer network. A product price in a merchant currency is presented to the user, and an account number representing a user account in a user currency is accepted from the user. The user does not input a price desired to be paid. Instead, the method includes undertaking currency conversion to determine whether the user account has sufficient funds to pay at least the product price, and then a transaction is allowed or not based on the conversion act.

In still another aspect, a system is disclosed that can be used for facilitating money transfer from a transferor having funds in a transferor currency in a transferor account to a transferee having funds in a transferee currency in a transferee account. The system includes a transaction computer that communicates with at least the transferor via the Internet, with the transaction computer being associated with a master account of funds in the transferor currency. The transaction computer debits funds from the transferor account in response to a communication from the transferor using a spread around an exchange rate between the currencies. These funds are moved to the master account. The computer then converts funds in the master account to funds in the transferee currency using an exchange rate, and then moves funds in the transferee currency into the transferee account.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a schematic diagram of preferred data structures;

FIGS. 3 and 3A are flow charts of the initialization logic;

FIG. 4 is a flow chart of the ordering logic;

FIG. 5 is a flow chart of the order processing logic; and

FIG. 6 is a flow chart of the currency exchange method.

### DETAILED DESCRIPTION OF THE PREFERRED EMBODIMENT

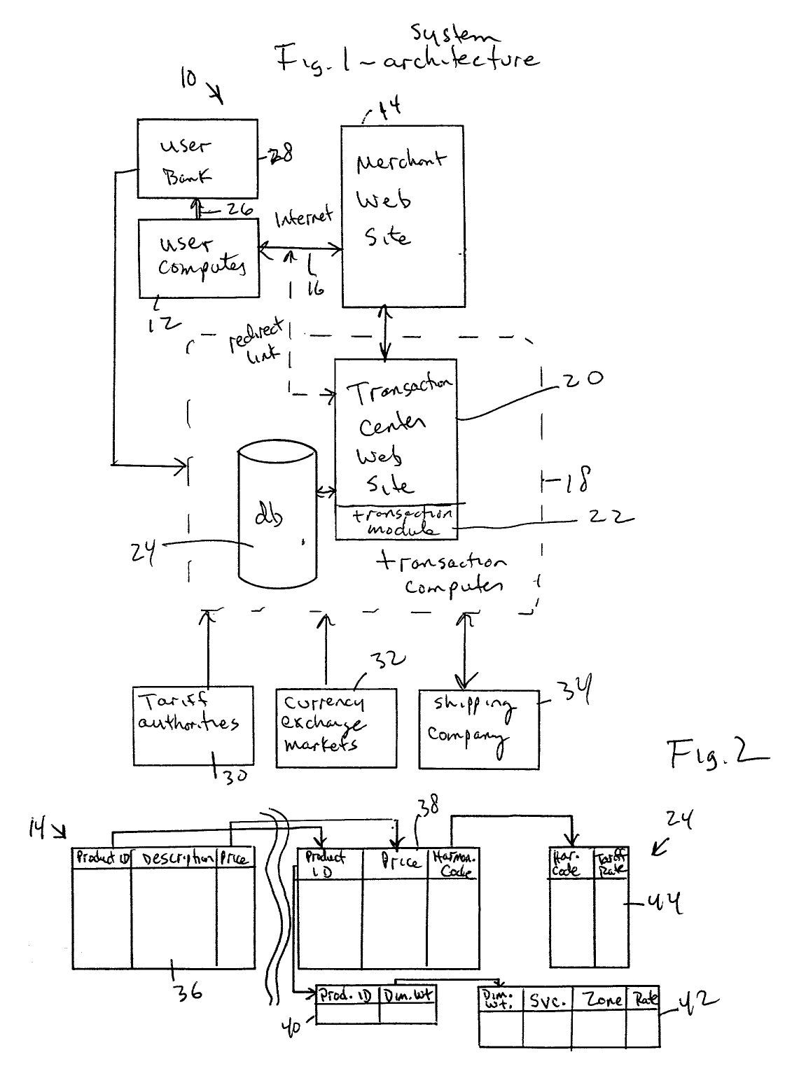

Referring initially to FIG. 1, a system is shown, generally designated 10, for facilitating international electronic commerce (e-commerce) between one or more user computers 12 and one or more merchant Web site computers 14 via the Internet 16, as coordinated by a transaction center computer 18 that controls a transaction center Web site 20 and that accesses the Internet. Thus, in the particular architecture shown the e-commerce is conducted using the World Wide Web, or “web” for short, although it is to be understood that other computer networks can be used as well.

In accordance with the present invention, the computers 12, 14, 18 can be any appropriate digital processing apparatus, such as a mainframe computer, personal computer, laptop computer, or palmtop computer made by International Business Machines Corporation (IBM) of Armonk, N.Y. or by Apple Computers. Or, any one of the computers 12, 14, 18 may be computers sold under trademarks such as AS400, with accompanying IBM Network Stations.

In accordance with the method described below, the transaction computer 18 accesses a transaction module 22 and a database 24, both of which can be, but need not necessarily be, implemented at the transaction center Web site 20. The transaction module 22 can be included in software contained in an appropriate electronic data storage that includes, e.g., a hard disk drive or optical disk drive that are conventionally coupled to the computer 18.

The flow charts herein illustrate the structure of the logic of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer) to perform a sequence of function steps corresponding to those shown.

In other words, the module 22 may be one or more computer programs that are executed by a processor within the computer 18 as a series of computer-executable instructions. In addition to the above-mentioned drives, these instructions may reside, for example, in RAM of the computer 18, or the instructions may be stored on a DASD array, magnetic tape, electronic read-only memory, or other appropriate data storage device. In an illustrative embodiment of the invention, the computer-executable instructions may be lines of compiled C⁺⁺ compatible code.

As indicated by the double line 26 in FIG. 1, the user of the user computer 12 accesses a bank 28. The user establishes an account at the bank 28, either a credit card account or more preferably a debit card account by depositing funds in the bank 28 in a user currency. The user can actually have multiple accounts in different currencies, but for simplicity of disclosure it is assumed that the user utilizes only a single user currency at the bank 28.

In turn, the bank 28 communicates user information to the transaction computer 18. The user information conveyed by the bank 28 preferably includes the user identification (“user ID”) and personal information number (“PIN”), as well as account balance. It is to be understood that the transaction center can have its own account in the user currency at the bank 28 or at another financial institution, for purposes to be shortly disclosed. Moreover, the transaction center has one or more accounts that are in merchant currencies at financial institutions, as set forth further below.

Continuing the description of the architecture of the system 10, tariff information provided by or derived from tariff authorities 30 is input to the transaction computer 18. Also, currency exchange rate information is provided by one or more currency markets 32 or other source of exchange rate information. Moreover, one or more shipping companies 34 provide shipping rate information to the transaction computer 18. This information can be provided directly from computers respectively associated with the tariff authorities 30, exchange rate markets 32, and shipping companies 34, or it can be manually gathered and then input to the transaction computer 18. In any case, the information is stored in the database 24, which can be implemented locally or remotely to the transaction computer 18 and which indeed can be implemented by more than one physical database.

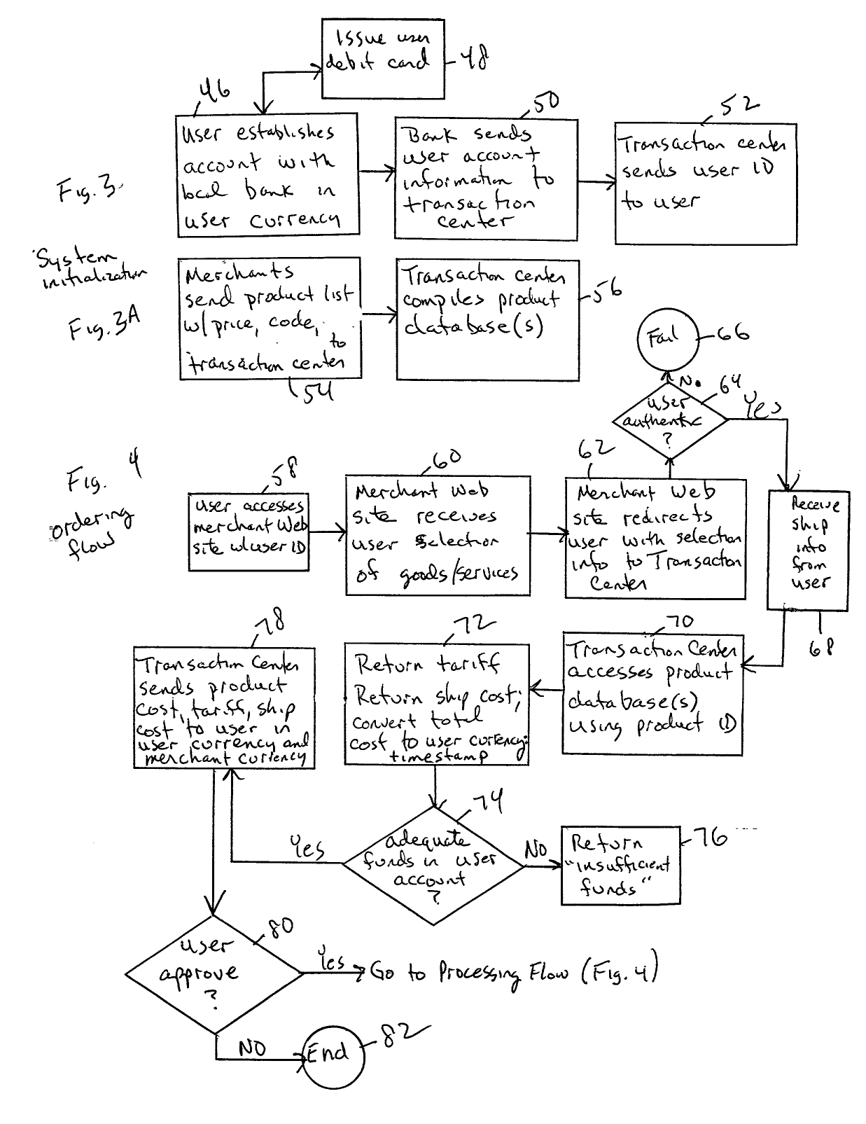

With particular regard to the just-described information, FIG. 2 illustrates preferred data structures that can be used to effect the data storage. As shown, each merchant computer 14 maintains a merchant product table 36 that lists product IDs, associated product descriptions, and associated prices. As used herein, “product” can refer to goods or services. When a user selects a product for purchase, the merchant computer 14 provides the associated product ID from the product table 36 to the transaction computer 18.

As shown in FIG. 2, the product ID is used as an entering argument to enter a transaction table 38 in the database 24, which correlates product IDs to prices, preferably in the merchant currency, and to harmonization codes. The product IDs can be used as entering arguments to a dimension weight table 40, which correlates product IDs to dimension weights. In turn, the dimension weights can be used as entering arguments to a shipping table 42, which correlates dimension weights to shipping services by zone, with each weight/service/zone combination being associated with a respective shipping rate (or cost) as provided by the shipping companies 34. Shipping information other than dimension weight can be used. On the other hand, the harmonization code from the transaction table 38 can be used as an entering argument to a tariff schedule 44, which correlates harmonization codes to tariff rates (or costs) as provided by the tariff authorities 30. It is to be understood that the term “tariff” as used herein can encompass tariffs, customs, import duties, sales taxes, and other government-mandated charges on transactions.

Attention is now directed to the flow charts to understand how the above architecture and data structures are used to implement the present logic. Commencing at block 46 in FIG. 3, the user establishes an account with the bank 28 in the user's currency. Moving to block 48, the bank 28 or other issuing authority issues a card, preferably a debit card, to the user along with a PIN. In parallel the bank sends user account information to the transaction computer 18 at block 50, and the transaction computer 18 then sends a user ID to the user at block 52 by any suitable means, preferably via the Internet.

FIG. 3A shows that to initialize the merchant computer 14/transaction computer 18 cooperation, at block 54 the merchant computer 14 sends the product table 36 to the transaction computer 18. Then, at block 56 the transaction computer compiles the data structures shown in FIG. 2 using the data provided by the merchants 14, the tariff authorities 30, and shipping companies 34.

Now referring to the flow charts, the preferred logic for enabling a user to purchase goods and services sold in a merchant currency across international boundaries using a debit card drawing on an account in a user currency can be seen. Commencing at block 58, the user computer 12 accesses the transaction center web site 20 with the associated user ID. Moving to block 60, the merchant computer 14 presents a display of available products and receives in response a user selection of a product or products to purchase, along with the debit card number and PIN of the user. Then, at block 62 the merchant computer 14 redirects the user computer 12 to the transaction center Web site 20, along with the product IDs of the products selected, the user ID, and debit card number.

Once the user is “virtually” located at the transaction center Web site 20, at decision diamond 64 the transaction computer 18 authenticates the user by means of one or both of the user ID and PIN, which the user can be prompted to enter. Moreover, public key/private key cryptology or other cryptology can be used. If the user is not authenticated, “fail” can be returned at state 66; otherwise, the user is authenticated.

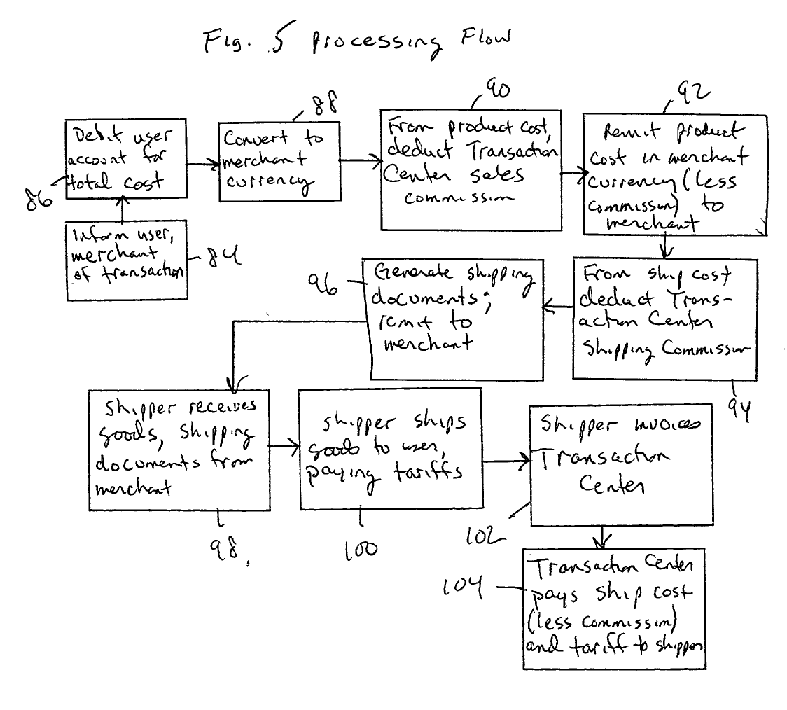

For users authenticated at decision diamond 64, the logic flows to block 68 to receive shipping information from the user. This information includes the address of the location to which the user desires the products to be shipped. Proceeding to blocks 70 and 72, the transaction computer 70 accesses the data structures shown in FIG. 2 to determine tariff costs and shipping costs. More specifically, at block 70 the transaction computer 18 correlates the product IDs to harmonization codes using the transaction table 38 and the delivery address provided by the user at block 68 in FIG. 4, and then using the tariff schedule 44 determines the tariff cost for the ordered products. Also, using the product ID the transaction computer 18 accesses the dimension weight table 40 to retrieve a dimension weight, and then using this as entering argument determines a shipping cost from the rate column of the shipping table 42, depending on the shipping address provided by the user.

Having determined the above costs, at block 72 the transaction computer 18 returns the tariff cost and shipping cost in the merchant currency, along with the product cost from the transaction table 38. These costs are added together and, for currency conversion purposes, timestamped. The costs that are returned to the user are calculated using the least favorable (to the user) exchange rate based on a spread around the actual exchange rate (at the time indicated by the timestamp), as more fully set forth below in reference to FIG. 6.

Then, the logic flows to decision diamond 74 to determine whether adequate funds exist in the user account. To do this, the transaction computer 18 accesses account information held by the transaction center as previously provided by the bank. Specifically, all user accounts in a bank are subaccounts of a master trust account affiliated with the transaction center, and the transaction computer 18 converts the amount of money in the user's account to merchant currency, using information provided by the currency exchange markets 32 as of the timestamp for the transaction as more fully set forth below in reference to FIG. 6. It should be understood that by “convert” is meant simply calculating the amount of money in the account in terms of the merchant currency, and not transferring funds at this point. If the resulting amount of money in merchant currency is less than the total cost of products returned at block 72, “insufficient funds” is returned at block 76. Of course, the above comparison can be determined in reverse, i.e., by converting the total price to user currency and then making the comparison in user currency.

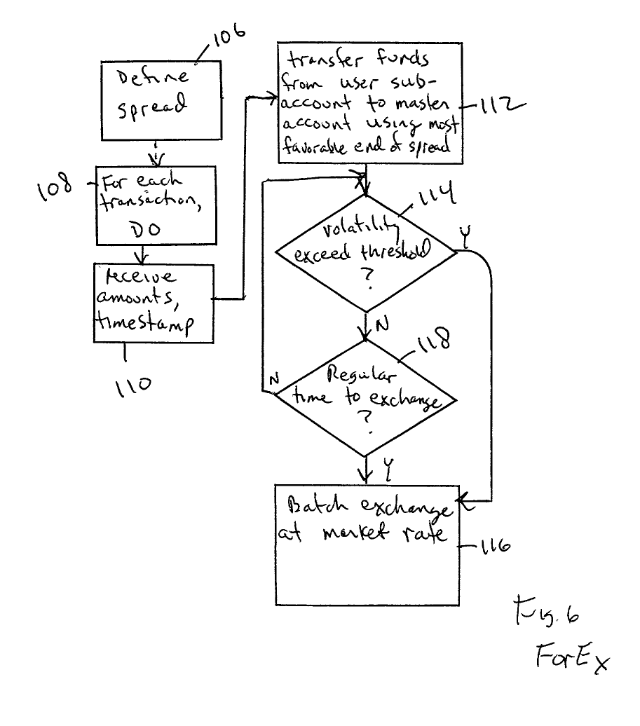

When sufficient funds are available, however, the logic flows to block 78 to send the total cost information directly to the user via the redirect link in both user currency and merchant currency. The user is then given the choice to approve the transaction at decision diamond 80, and if the user declines, the process ends at state 82. Otherwise, the logic continues to FIG. 5.

Commencing at block 84 in FIG. 5, the transaction computer 18 informs the user computer 12 and merchant computer 14 that a transaction has been approved. Moving to block 86, the user account is debited for the total cost determined at block 72 in FIG. 4. In the preferred embodiment, the money is simply transferred from the user's subaccount into a master account affiliated with the transaction center authority at the bank 28 or other institution in user currency. Then, the money is converted to merchant currency at block 88, as set forth further below in reference to FIG. 6. This conversion need not be undertaken with every transaction, although it could be. Regardless, once converted the money can be transferred to a transaction center trust account held in merchant currency.

In any case, the logic moves to block 90, wherein a transaction center sales commission in the form of a merchant discount is deducted from the product cost and applied to a transaction center commission account. Then, the product cost (less merchant discount) is remitted to the merchant from funds in the transaction center trust account at block 92.

It may now be appreciated that no user information other than identity and shipping address is sent to the merchant's Web site to effect a transaction. Thus, the user need not fear that an unscrupulous person with access to the merchant's Web site will steal the user's account information, such as the user's PIN or debit/credit card number. Instead, user account information is accessed solely by the secure transaction center, which being only a single (or small number of) Web sites can be made secure more reliably than can perhaps tens of thousands merchant sites. The account verification and currency conversion process is executed transparently to the merchant, who simply receives the agreed-upon purchase price (less merchant discount) in merchant funds from the transaction center without any risk of currency conversion and without having to access user accounts.

Moving to block 94, a transaction center shipping commission can be deducted from the shipping cost and applied to the transaction center commission account. Then, the transaction computer 18 generates shipping documents, such as shipping manifests, at block 96 based on the product ID, shipping address, tariffs, and so on in accordance with procedures known in the art, and these shipping documents are sent electronically or otherwise to the respective merchants. The merchants then transfer the products with shipping documents to an in-house or contracted shipping company at block 98, which in turn ships the goods at block 100 to the address provided by the user at block 68 of FIG. 4, paying necessary tariffs as determined by the transaction center and reflected on the shipping documents. The shipper then invoices the transaction center for shipping costs and tariffs at block 102, and is paid the shipping cost (less shipping commission, if any) and tariff costs at block 104 by the transaction center. The transfers of funds described above preferably are effected electronically between computers but can be manually undertaken if desired.

Now referring to FIG. 6, for each possible merchant currency-user currency combination, a predefined spread is defined at block 106. For instance, the spread can be a 5% spread around a nominal exchange rate. As the exchange rate moves, the spread moves to maintain the current exchange rate in the center of the spread.

When a transaction is executed, the logic enters a DO loop at block 108. At block 110, the relevant amounts and transaction timestamp are received. Proceeding to block 112, funds are transferred from the transacting user's subaccount to the transaction center's master trust account using the most favorable (to the transaction center, least favorable to the user) end of the spread. It is this end of the spread that is used to calculate tariffs and shipping and to present the user with a cost of transaction in the user currency that has been described above.

Decision diamond 114 essentially represents a state wherein a volatility (and direction) for at least one of the currencies involved in the transaction, as reported by, e.g., a real-time quote service, exceeds a threshold. When it does, the logic moves to block 116 to immediately effect a batch exchange of user funds in the master trust account to merchant funds at the prevailing market rate. Moreover, decision diamond 118 essentially represents a state wherein at the end of a predetermined period, say, daily, the batch exchange of funds in the master account is undertaken by moving to block 116.

To illustrate, suppose the user currency is the peso and the merchant currency is the dollar, and the current exchange rate at the time of a transaction timestamp is 9.5 pesos to the dollar. Further suppose that the spread is 0.5 pesos (static). Accordingly, one end of the spread would be 9.25 pesos to the dollar, and the other end would be 9.75, in this hypothetical.

If the user purchases a product priced at $1000, the price that is returned by the transaction computer 18 in terms of user currency would be 9750 pesos, i.e., the end of the spread least advantageous to the user and, thus, least risky (most advantageous) to the transaction center. Conversely, for a user having an account in dollars purchasing an item in pesos, the exchange rate used to calculate the cost of goods in the user currency (dollars) would be 9.25 pesos to the dollar. In this way, the transaction center's exposure to fluctuations in exchange rates is minimized.

The transaction computer 18 can use the logic of FIG. 6 to effect money transfer from a person in one country to a person in another country, if both people are users in the system 10. This can occur simply by enabling the transferor to indicate a desire to transfer funds in his or her account held in what can be regarded as the user currency to an account held by the transferee, with conversion into the transferee's currency (which can be regarded as the merchant currency) occurring according to the logic of FIG. 6. It will be 5 appreciated that the transaction center's fee for the transfer would be the difference between the actual exchange rate at the time of batch conversion and the relevant end of the spread at the time of the timestamp of the transfer.

While the particular METHOD AND SYSTEM FOR INTERNATIONAL E-COMMERCE as herein shown and described in detail is fully capable of attaining the above-described 10 objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A computer-implemented method for international e-commerce, comprising the acts of:
accessing, based on at least one user having an account in a user currency accessing at least one merchant computer site and selecting one or more products for purchase, respective purchase prices in a merchant currency;
determining a tariff, if any, for at least one product;
determining a shipping charge, if any, for at least one product;
determining whether sufficient funds exist in the user account to cover at least the purchase price or prices of the products;
if sufficient funds exist in the user account, allowing a transaction to occur;
debiting the user account an amount in the user currency at least equal to the purchase price plus shipping charge plus tariff;
providing the merchant with funds in the merchant currency pursuant to the transaction; and
providing the shipping cost and tariff to at least one of: the merchant, and a third party shipper.

2. The method of claim 1, further comprising redirecting the user to a transaction center after the permitting act, the transaction center undertaking at least the determining acts.

3. The method of claim 2, further comprising determining a merchant discount based on the transaction, and associating the merchant discount with an account associated with the transaction center.

4. The method of claim 2, further comprising determining a shipping commission based on the shipping charge, and associating the shipping commission with an account associated with the transaction center.

5. The method of claim 1, further comprising storing information pertaining to tariffs for use thereof during the act of determining a tariff.

6. The method of claim 1, further comprising:
receiving from the user a shipping address; and
storing information pertaining to shipping charges for use thereof during the act of determining a shipping charge.

7. The method of claim 6, wherein the information pertaining to shipping charges at least partially accounts for weights of goods.

8. The method of claim 2, further comprising the act of presenting to the user a total cost in both the user currency and the merchant currency.

9. The method of claim 1, further comprising the acts of:
appending at least one timestamp to at least one transaction; and
using the timestamp during the act of determining whether sufficient funds exist.

10. The method of claim 9, wherein the act of determining whether sufficient funds exist further comprises calculating a currency conversion between the user currency and merchant currency using a spread around an exchange rate.

11. The method of claim 10, wherein the exchange rate is determined based on the timestamp.

12. The method of claim 2, further comprising:
generating at least one shipping document pursuant to the transaction; and
shipping the product in accordance with the shipping document and shipping cost.

13. A computer system for international electronic commerce, comprising:
at least one user computer;
at least one merchant computer accessible to the user computer via a wide area computer network, such that a transaction for goods or services can be undertaken by the computers; and
at least one transaction center computer accessing the network, the transaction center computer determining shipping costs and tariff costs based on the transaction and using user account data, whereby the merchant computer does not receive the user account data.

14. The system of claim 13, wherein the user computer is associated with an account in a user currency and the goods or services have a purchase price in a merchant currency, and the transaction center computer is programmed to receive, from the user computer, a shipping address, and to determine a tariff at least partially based on the shipping address.

15. The system of claim 14, wherein the transaction center computer is programmed to determine a shipping charge at least partially based on the shipping address.

16. The system of claim 15, wherein the transaction center computer is programmed to determine whether sufficient funds exist in the user account to cover at least the purchase price or prices of the products, and if sufficient funds exist in the user account, to allow a transaction to occur.

17. The system of claim 16, wherein the transaction center computer is programmed, if the user agrees to the transaction, to debit the user account an amount in the user currency at least equal to the purchase price plus shipping charge plus tariff, to provide the merchant with funds in the merchant currency pursuant to the transaction, and to provide the shipping cost and tariff to at least one of: the merchant, and a third party shipper.

18. The system of claim 13, wherein the merchant computer redirects the user computer to the transaction center after the user computer accesses the merchant computer.

19. The system of claim 13, wherein the transaction center computer determines at least one of: a merchant discount based on the transaction, and a shipping commission based on a shipping charge associated with the transaction, and the transaction center computer associates a commission with an account associated with the transaction center.

20. The system of claim 13, wherein the transaction center computer appends a timestamp to the transaction, the transaction center computer using the timestamp to determine whether sufficient funds exist in a user account associated with the user computer to cover the transaction.

21. The system of claim 13, wherein the transaction center computer generates a shipping document pursuant to the transaction.

22. The system of claim 13, wherein the transaction center computer is programmed to calculate a currency conversion between the user currency and merchant currency using a spread around an exchange rate.

23. A computer program product useful for causing a computer to undertake international e-commerce over the world wide web, comprising:
logic means for determining, in at least a user currency, a sales cost for a product having a sales cost listed on a merchant web site in a merchant currency;
logic means for determining at least a shipping cost associated with the product; and
logic means for presenting to a user a total cost of the product, the total cost including at least the sales cost and shipping cost.

24. The computer program product of claim 23, further comprising:
logic means for determining at least a tariff associated with the product, the total cost including the tariff.

25. The computer program product of claim 23, further comprising:
logic means for converting funds in a user currency in a user account associated with the user to funds in a merchant currency;
logic means for determining whether the funds in the user account are sufficient to cover the total cost; and
logic means for permitting a transaction to occur regarding the product if the funds in the user account are sufficient to cover the total cost.

26. The computer program product of claim 25, further comprising logic means for generating a shipping document related to the product.

27. The computer program product of claim 26, further comprising logic means for determining at least one commission related to the transaction.

28. The computer program product of claim 25, wherein the logic means for converting funds calculates a currency conversion between the user currency and merchant currency using a spread around an exchange rate.

29. A method for undertaking e-commerce, comprising:
establishing communication between a user computer and a merchant computer via a wide area computer network;
presenting to the user a product price in a merchant currency;
accepting from the user an account number representing a user account in a user currency, the user not inputting a price desired to be paid;
undertaking currency conversion to determine whether the user account has sufficient funds to pay at least the product price; and
allowing a transaction or disallowing a transaction, based on the conversion act.

30. A system for facilitating money transfer from a transferor having funds in a transferor currency in a transferor account to a transferee having funds in a transferee currency in a transferee account, comprising:
a transaction computer communicating with at least the transferor via the Internet, the transaction computer being associated with a master account of funds in the transferor currency, the transaction computer debiting funds from the transferor account in response to a communication from the transferor using a spread around an exchange rate between the currencies, the computer moving the funds to the master account, the computer converting funds in the master account to funds in the transferee currency using an exchange rate, the computer moving funds in the transferee currency into the transferee account.
